(19) United States
(12) Patent Application Publication
(10) Pub. No.: US 2007/0106405 A1
(43) Pub. Date: May 10, 2007

(54) METHOD AND SYSTEM TO PROVIDE REFERENCE DATA FOR IDENTIFICATION OF DIGITAL CONTENT

(75) Inventors: Randall E. Cook, Kensington, CA (US); Timothy I. Hentzel, San Francisco, CA (US); Steven D. Scherf, Emeryville, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Gracenote, Inc.

(21) Appl. No.: 11/466,056

(22) Filed: Aug. 21, 2006

Related U.S. Application Data
(60) Provisional application No. 60/709,543, filed on Aug. 19, 2005.

(51) Int. Cl. G06F 17/00

(52) U.S. Cl. 700/94

(57) ABSTRACT

Source data is accessed for a content portion of digital content. The source data is usable to identify the content portion. The reference data is defined for the content portion by clustering the accessed source data. The reference data is usable to identify the content portion.

### CROSS-REFERENCE TO RELATED APPLICATIONS

This application claims the benefit of United States Provisional Patent Application entitled, “Method and System to Provide Reference Data for Identification of Digital Content,” Ser. No. 60/709,543, filed 19 Aug. 2005, the entire contents of which is herein incorporated by reference.

### TECHNICAL FIELD

This application relates to a method and system to process digital media fingerprints, for example, to create a database of reference fingerprints.

### BACKGROUND

Identification is a process by which, for example, digital audio is recognized as being the same as the original or reference recording. Automatic identification may be used to identify sound recordings for the purposes of registration, monitoring and control, all of which may be important in ensuring the financial compensation of the rights owners and creators of music. Automatic identification may add value to, or extract value from the music. Registration is a process by which the owner of content records his or her ownership. Monitoring may record the movement and use of content so that it can be reported back to the owner, generally for purposes of payment. Control includes a process by which the wishes of a content owner regarding the use and movement of the content are enforced.

Some examples of adding value to music include: identification of unlabelled or mislabeled content to make it easier for users of the music to access and organize their music and identification so that the user can be provided with related content, for example, information about the artist, or recommendations of similar pieces of music.

An approach to identifying digital audio is to use intrinsic properties of the music to provide a “fingerprint.” The identifying features are a part of the music, therefore changing the music results in different features. However, with the explosive growth of digital music as a result of the Internet, the speed and accuracy required to accomplish effective identification of extremely high numbers of digital audio tracks (e.g., songs) is now of greater importance.

Typically, a fingerprint of digital audio received is compared with reference fingerprints in a database in order to identify the audio. However, the reference database may have several fingerprints associated with a single song, making identification less efficient as a result of redundant matches.

### BRIEF DESCRIPTION OF DRAWINGS

Some embodiments are illustrated by way of example and not limitation in the figures of the accompanying drawings in which:

FIG. 1 is a block diagram of a media system according to an example embodiment;

FIG. 2 is a block diagram of a digital audio system according to an example embodiment;

FIG. 3 is a flowchart illustrating a method for obtaining reference fingerprints according to an example embodiment;

FIG. 4 shows an example clustering method to provide reference data for identification of digital content;

FIG. 5 is a distance table according to an example embodiment;

FIG. 6 is a distance table according to an example embodiment;

FIG. 7 is a match table according to an example embodiment;

FIG. 8 is an example average distance table;

FIG. 9 is a flowchart illustrating a method for selecting reference data according to an example embodiment;

FIG. 10 is a distance table according to an example embodiment;

FIG. 11 is a match table according to an example embodiment;

FIG. 12 is an example average distance table;

FIG. 13 is a flowchart illustrating a method for receiving text metadata according to an example embodiment;

FIG. 14 is a flowchart illustrating a method for providing text metadata according to an example embodiment;

FIGS. 15 and 16 show flowcharts of an example method for searching a database of reference fingerprints; and

FIG. 17 illustrates a diagrammatic representation of an example machine in the form of a computer system within which a set of instructions, for causing the machine to perform any one or more of the methodologies discussed herein, may be executed.

### DETAILED DESCRIPTION

A method and system to provide reference data for identification of digital content is described. In the following description, for purposes of explanation, numerous specific details are set forth in order to provide a thorough understanding of an embodiment of the present invention. It will be evident, however, to one skilled in the art that the present invention may be practiced without these specific details.

Although the method and system are described by way of example with reference to digital audio, it will be appreciated to a person of skill in the art that it may be utilized to identify any digital data (e.g., video data).

In an example embodiment, a method of clustering is provided that may be utilized to process digital data and define reference digital data for storing in a reference database. The method may take a set of data (e.g., a number of digital fingerprints of known digital data) and filter it into a smaller set, taking advantage of high similarity of elements of groups within the set (or cluster) to exclude those elements that can be represented by other elements without significant change in the character of the overall set (e.g., without a significant reduction in coverage of the set). In an example embodiment, a scalar distance function is available to compare any two elements of the set. Further, a scalar threshold of similarity within the range of the distance function may be provided.

When the digital data is, for example audio data such as a song, for each song entry in a song database, many audio fingerprints may be provided. Most of the time, these fingerprints may be extremely similar and such similar fingerprints may be classified as a cluster or set. It may be inefficient to index all these similar fingerprints for queries to identify digital content. In an example embodiment, a clustering method described by way of example herein may be used to select the most representative fingerprint in this cluster and index the selected fingerprint using the most representative fingerprint thereby to potentially create more efficient queries. At the same time, in an example embodiment, if some fingerprints lie outside the cluster, they are included as well. Within a set of fingerprints associated with a song, a subset may be highly self-similar, while other subsets (possibly single fingerprints) are not similar to that subset. It may make for efficient queries if all subsets of fingerprints for a given song are reduced to as few members as possible, without significant reduction in overall coverage.

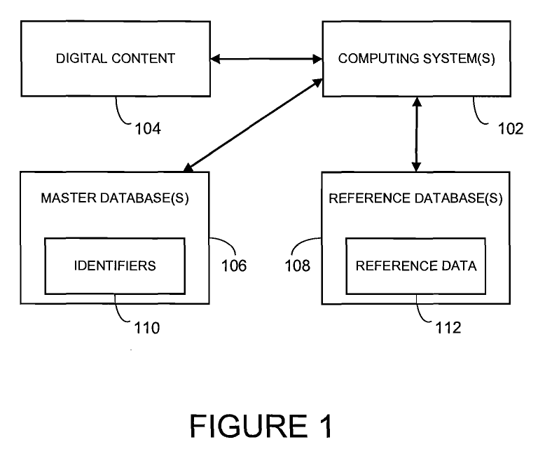

Referring to FIG. 1, a media system 100 in accordance with an example embodiment is illustrated. As illustrated, the media system 100 may include a computing system 102 in communication with digital content 104, one or more master databases 106 and one or more reference databases 108.

The computing system 102 may process portions of the digital content 104 to create and store one or more identifiers 110. For example, the digital content 104 may include digital content items such as still pictures/photographs, video (e.g., DVDs), audio (e.g. songs) or any other digital media. An example embodiment of the computing system 102 is described in greater detail below.

Each of the identifiers 110 may be data used to identify the digital content 104. For example, the identifiers 110 may be used to identify a title of a movie, an artist and song name for a digital audio track (e.g., a song), a name and photographer of a picture/photograph, and the like. In an example embodiment, the identifiers 110 may be created by taking a fingerprint of each of the portions of the digital content 104.

Reference data 112 may be provided by clustering the identifiers 110 and then storing the clustered reference data 112 in the reference database 108. For example, the reference data 112 may be used to identify a title of a movie, an artist and song name for a digital audio track, a name and photographer of a photo, and the like. In an example embodiment, the clustering method may be used to identify a subset of the identifiers 110 used to identify the digital content 104 to include as the reference data 112 that is still capable of identifying the same digital content 104.

In an example embodiment, the reference database 108 may be incorporated in a portable unit that plays recordings, or accessed by one or more servers processing requests received via the Internet from hundreds of devices each minute, or anything in between, such as a single desktop computer or a local area network.

In an example embodiment, a method of providing identifiers 110 associated with known items of digital content 100 may include for each known digital content item of a plurality of content items, generating a plurality of identifiers 110 associated with the known digital content item, identifying at least two similar identifiers 110 among the plurality of identifiers 110, and storing a reference set of identifiers 110 (e.g., reference data 112) that excludes at least one similar identifier 110.

In an example embodiment, the reference database 108 may be accessed to identify a reference set corresponding to the at least one associated identifier 110, the reference set including a plurality of known identifiers 110 generated from the known digital content item 104 and in which reference set no similar content item identifiers 110 are provided.

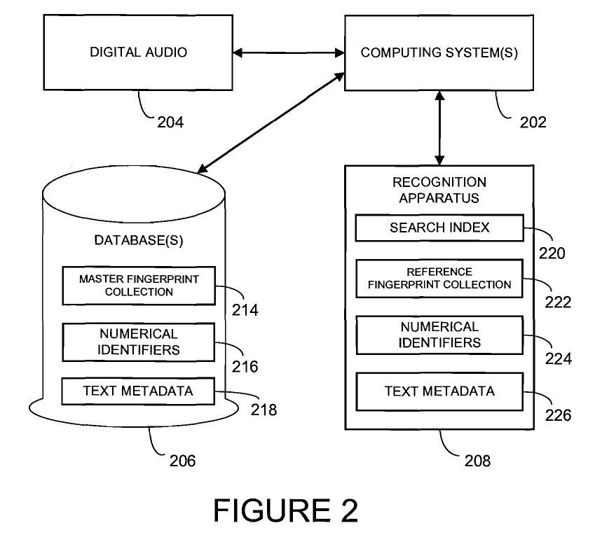

Referring to FIG. 2, a digital audio system 200 in accordance with an example embodiment is illustrated. As illustrated, the media system 200 may include a computing system 202 in communication with digital audio 204, one or more databases 206, and one or more recognition apparatus 208. In an example embodiment, the media system 100 (see FIG. 1) may include the media system 200.

The computing system 202 may process one or more digital audio tracks from the digital audio 204 to create and store a number of fingerprints as a master fingerprint collection 214. For example, the digital audio 204 may include digital audio tracks from a number of compact discs (CDs) and/or digital versatile discs (DVDs). In an example embodiment, the digital audio 204 may include a number of MPEG-1 Audio Layer 3 (MP3) digital audio tracks. However, in an example embodiment other types of the digital audio 204 are also accommodated. An example embodiment of the computing system 202 is described in greater detail below.

The master fingerprint collection 214 may include a number of fingerprints (e.g., a set of fingerprints) for a single digital audio track (e.g., a single song). For example, the fingerprints for the digital audio 204 may be submitted by multiple persons from different computing systems 202, such that a first number of the retained fingerprints for a single digital audio track may be very similar, while a second number of the retained fingerprints for a single digital audio track may be different. In an example embodiment, multiple fingerprints may be collected by the master fingerprint collection 214 to provide adequate coverage for queries. In an example embodiment, all fingerprints that are not identical may be retained in the master fingerprint collection 214.

In an example embodiment, the fingerprints may include digital media fingerprints. In an example embodiment, the fingerprints may include digital audio fingerprints.

In an example embodiment, the master fingerprint collection 214 may retain each different fingerprint received for a digital audio track. For example, a different fingerprint may be received for a same digital audio track and stored within the master fingerprint collection 214 based on a source of the digital audio 204. For example, the source may differ based on printing (e.g., a first printing versus a second printing), source (original versus copy), album inclusion (e.g., album release versus inclusion on a greatest hits album), country purchase (e.g., United States versus United Kingdom), store purchased (e.g., BEST BUY versus WAL-MART), and the like. In an example embodiment, the master fingerprint collection 214 may include an upper maximum or ceiling number (e.g., 10, 100, and 1000) of fingerprints retained for a digital audio track.

In an example embodiment, a fingerprint may include thirty integers and be in a value range of zero to thirty-two thousand. In an example embodiment, a fingerprint may be created by analyzing a digital audio track and subjecting the track to digital signal processing and statistical analysis. Each fingerprint may map to an album identifier and a track number.

In an example embodiment, once fingerprints for a digital audio track are received by the database 206, the fingerprints may be bound to a particular TOC (Table of Contents) record in the database 206, where the TOC record may be a collection of text metadata 218 associated with an album (e.g., a CD).

The database 206 may, for example, include numerical identifiers 216 and text metadata 218. The text metadata 218 of the database 206 may include an album name, an artist name, a track title, a genre, a year, notes, and/or table of contents (TOC) for CDs and DVDs.

The text metadata 218 may be associated with a numerical identifier 216, and a fingerprint from the master fingerprint collection 214 may be associated with the numerical identifier 216. For example, a query of the database 206 may match multiple fingerprints in the master fingerprint collection 214, numerical identifiers 216 may be obtained for the matched multiple fingerprints, and the text metadata 218 may be provided for the numerical identifiers 216.

One or more recognition apparatus 208 may include a search index 220 to provide query access to a reference fingerprint collection 222. In an example embodiment, the recognition apparatus 208 may be embedded in a device such as a digital music player that may be located within an MP3 player, a sound system in an automobile, and the like. In an example embodiment, the recognition apparatus 208 may be available to a device over a network through a network connection.

The reference fingerprint collection 222 may include a representative set of fingerprints from the master fingerprint collection 214. For example, the reference fingerprint collection 222 may include a subset of the fingerprints included within the master fingerprint collection 214. An example embodiment for selecting fingerprints for the reference fingerprint collection 222 is described in greater detail below.

In an example embodiment, a query to the reference fingerprint collection 222 may be quicker than a query to the master fingerprint collection 214 because the reference fingerprint collection 222 may include less fingerprints that the master fingerprint collection 214. In an example embodiment, the reference fingerprint collection 222 may provide comparable coverage for identifying digital audio as compared to the master fingerprint collection 214 since the reference fingerprint collection 222 has been selected by a clustering method.

The text metadata 226 may be associated with a numerical identifier 224, and a fingerprint from the reference fingerprint collection 222 may be associated with the numerical identifiers 224. For example, a query of the recognition server 208 may match one or more fingerprints in the reference fingerprint collection 222, numerical identifiers 224 may then be obtained for the one or more matched fingerprints, and thereafter the text metadata 226 may be provided for the one or more numerical identifiers 224.

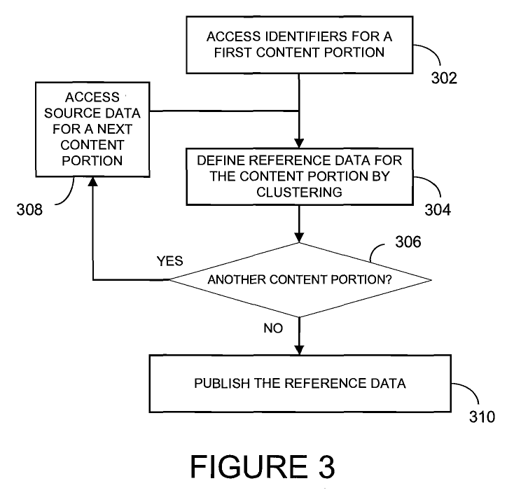

Referring to FIG. 3, a method 300, in accordance with an example embodiment, is illustrated for obtaining reference data. In an example embodiment, the method 300 may operate on the computing system 102, 202 (see FIGS. 1 and 2).

Identifiers 110 of a first content portion may be accessed at block 302. For example, the identifiers 110 may include the master fingerprint collection 214 (see FIG. 2) and the first content portion may be a first digital audio track (e.g., a song), such that the fingerprints for the first digital audio track are accessed.

Reference data 112 may be defined for the content portion of identifiers 110 by clustering (see block 304). In an example embodiment, the reference data 112 may be the reference fingerprint collection 222, such that one or more reference fingerprints are selected for each digital audio track from the master fingerprint collection 214. An example embodiment of clustering is described in greater detail below.

At decision block 306, a determination may be made as to whether another content portion is available. If another content portion is available, the method 300 may access the identifiers 110 for another content portion (e.g., another digital audio track) of the digital content 104 at block 308 and return to block 304. If another content portion is not available (e.g., all digital audio tracks have been accessed) at decision block 306, the method 300 may publish the reference data 112 at block 310 and then terminate. In an example embodiment, publishing the reference data 112 may include publishing the reference fingerprint collection 222 to the recognition server 208.

In an example embodiment, the reference data 112 may be indexed at block 310, such that the reference data 112 may be made for search inquiries of the reference data 112.

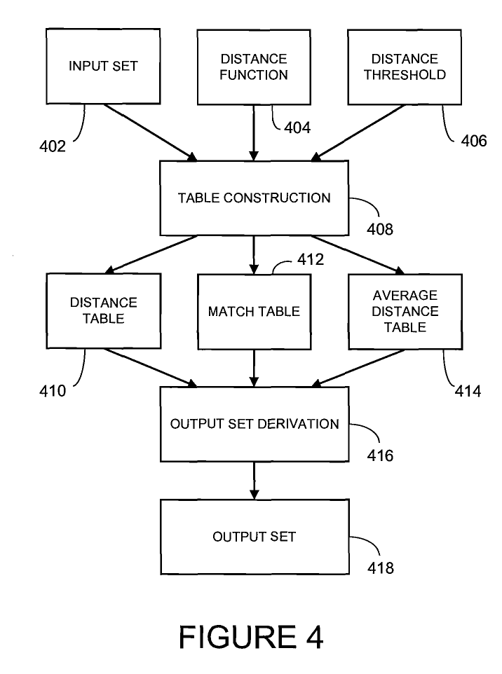

Referring to FIG. 4, an example clustering method 400 to provide the reference data 112 for identification of the digital content 104 is illustrated. The clustering method 400 may include an input set 402, an output set 418, a distance function 404, a distance threshold 406, three example tables 410, 412, 414 and a sequence of operations 408 for creating the tables 410, 412, 414 and deriving the output set 418 from the input set 402. It will however be appreciated that other embodiments of the clustering method 400 may include additional components and/or different components. For example, conceptual use of the three tables 410, 412, 414 is illustrated to show the retention of information used in deriving the output set 416 and may not be used in some embodiments. The elements of the input set 402 and output set 418 may be arbitrary data. In an example embodiment, the elements may all be of the same type, and within the domain of the distance function 404. The input set 402 may, for example, be determined by performing a TOC search to identify all instances of a single digital audio track.

The distance function 404 may take any two elements of the input set 402 and produce a value indicating the distance between the two elements within their particular space. The distance threshold 406 may represent a distance below which two data elements can be considered functionally equivalent. Accordingly, either data elements can be used in subsequent operations without significantly affecting the results.

In an example embodiment, the distance function 404 may compute the difference between the elements of the input set 402 (e.g., reference data for a same portion of digital content and/or fingerprints for a single digital audio track) to receive a number of distances values. The distances values may be may be a relative measure that is a scalar number, where a value of zero means identical and larger than zero means more distant.

For example, the distance function 404 may include a method involving applying logarithms, geometric means, and/or arithmetic means. In an example embodiment, the distance function 404 may be an Itakura distance function (F. Itakura, Minimum Prediction Residual Principle Applied to Speech Recognition.” IEEE Transactions on Acoustics, Speech, and Signal Processing, Vol. ASSP-23, No. 1, February 1975). In some example embodiments, the distance function 404 may be a Levenshtein/edit distance function, a Euclidian distance function, a cross product distance function, or the like. It should be noted that other distance functions may also be utilized.

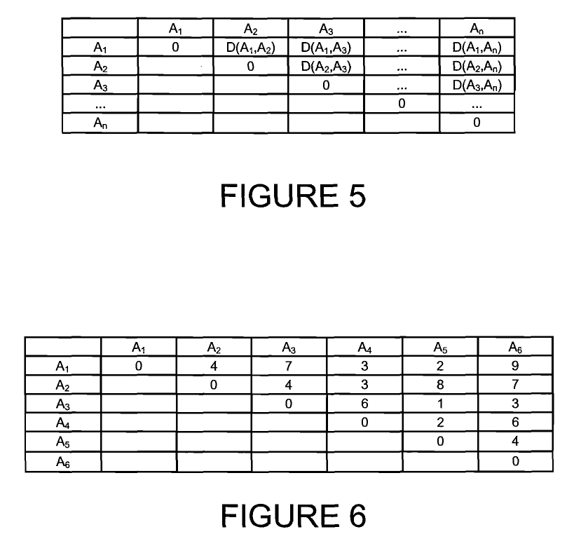

The distance table 410 may conceptually hold the distance values from each input element to all others input elements. It does not need to physically exist in an embodiment, but the information it contains may exist in some form. Given an input set A containing N elements, and a distance function D, the distance table 410 may look like the table 500 shown in FIG. 5. The table 500 only shows an upper triangular portion of the distance table because the example distance function 404 is symmetrical. An example distance table 600 with concrete values is shown in FIG. 6.

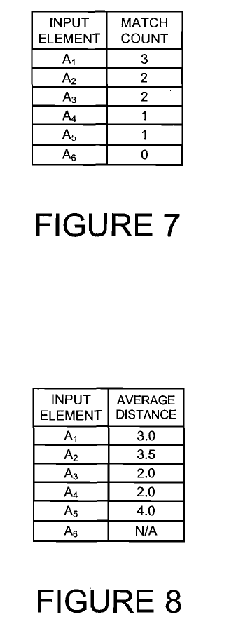

The match table 412 may conceptually list the number of elements whose distance from each input element is below the distance threshold 406. It does not need to physically exist in an embodiment, but the information it contains may exist in some form. The match table 412 may be derived by counting the number of entries along each row of the distance table 410 whose value is less than the distance threshold 406. An example distance table 700 with concrete values is shown in FIG. 7.

The average distance table 414 may conceptually list the average distance from each input element to those elements that are within the distance threshold 406 of it. It does not need to physically exist in an embodiment, but the information it contains may exist in some form. An example average distance table 800 with concrete values is shown in FIG. 8.

In an example embodiment, values of the distance table 410 may be scaled, such as to reflect a value of zero to nine. It should be appreciated that other tables of the clustering method 400 may then be similarly scaled.

The distance threshold 406 may be a fixed or variable value. In an example embodiment, the distance threshold 406 may be a dynamically computed distance threshold. Multiple distance thresholds 406 may be used to determine coverage size versus size of the reference data 112 in the reference database 108.

Referring to FIG. 5, the example distance table 500 is shown to include Aₙ rows by Aₙ columns, where each cell of the distance table 500 may be a distance between a first element n and a second element n. However, as illustrated, it may not be desirable to include a same comparison (e.g., a first comparison between element 3 and element 5 and a second comparison between element 5 and element 3) or a self comparison (e.g., element 4 with element 4).

Referring to FIG. 6, the example distance table 600 as illustrated includes discrete values as follows: A₁, A₁ (0); A₁, A₂ (4); A₁, A₃ (7); A₁, A₄ (3); A₁, A₅ (2); A₁, A₆ (9); A₂, A₂ (0); A₂, A₃ (4); A₂, A₄ (3); A₂, A₅ (8); A₂, A₆ (7); A₃, A₃ (0); A₃, A₄ (6); A₃, A₅ (1); A₃, A₆ (3); A₄, A₄ (0); A₄, A₅ (2); A₄, A₆ (6); A₅, A₅ (0); A₅, A₆ (4); and A₆, A₆ (0).

The match table 700 (see FIG. 7) may be computed from the distance table 600 and is shown by way of example to utilize a distance threshold of five (see FIG. 6). As illustrated the match table 700 includes match counts as follows: A₁ (3), A₂ (2), A₃ (2), A₄ (1), A₅ (1), and A₆ (0), where each of the match counts reflects the number of values in a row of the distance table 600 where the value was below the distance threshold.

The average distance table 800 (see FIG. 8) may be computed from the distance table 410 and as illustrated includes average distances as follows: A₁ (3.0), A₂ (3.5), A₃ (2.0), A₄ (2.0), A₅ (4.0), and A₆ (N/A). The average distances may be the average distance between the element and all other elements to which it is compared and matched. For example, A₁ may be computed as follows: (4+3+2)/3=3.0.

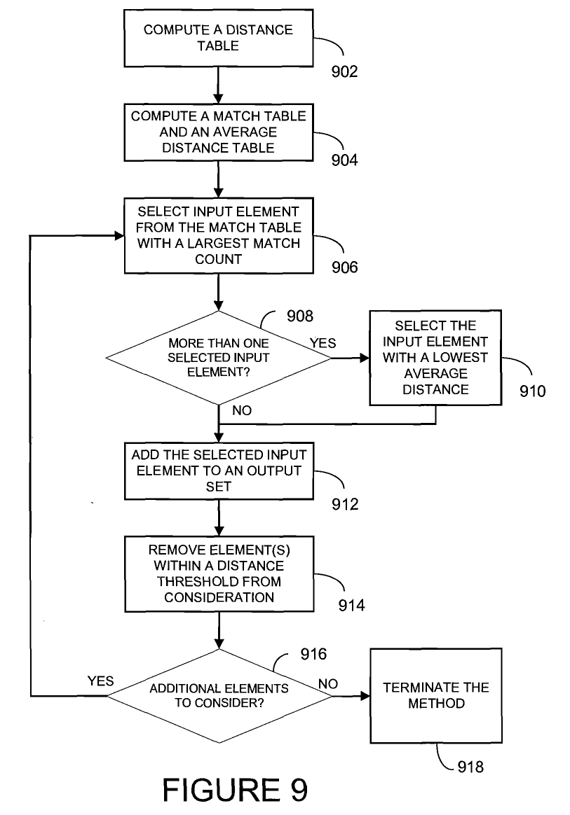

FIG. 9 shows an example clustering method 900 to provide reference data for identification of digital content. In an embodiment, the method 900 may facilitate audio fingerprint queries from a local database and be suitable for execution on very modest hardware (133 MHz CPU, 1 MB RAM). The method 900 may extend the range of devices that can support audio fingerprint queries. In an example embodiment, the method 900 may be deployed and integrated into any audio equipment such as mobile mp3 players, car radios, or the like.

The example clustering method 900 may be used to provide reference data 112 for identification of digital content 104. In an example embodiment, the method 900 may be performed on the computing system 102 (see FIG. 1).

The distance table 410 may be computed at block 902 (see FIG. 4). The match table 412 and the average distance table 414 may be computed at block 904.

By way of an example, the distance table 410 may be computed as the distance table 600, the match table 412 may be computed as the match table 700, and the average distance table 414 may be computed as the average distance table 800 (see FIGS. 6-8).

An input element with a largest match count may be selected from the match table 412 at block 906. The largest match count of the match table 700 is shown to be A₁. In an example embodiment, the largest match count may be determined by calculating a number of matches from a number of the distance values below a distance threshold for each of the fingerprints included as input elements.

At decision block 908, the method 900 may determine whether more than one input element was selected as having the largest match count. If more than one input element was selected, the method 900 may select the input element with a lowest average distance at block 910. If more than one input element was not selected at decision block 908 or after block 910, the method 900 may proceed to block 912.

The selected input element may be added to an output set 418 at block 912. By way of example, A₁ may be added to output set 418 as having the largest match count of the match table 700.

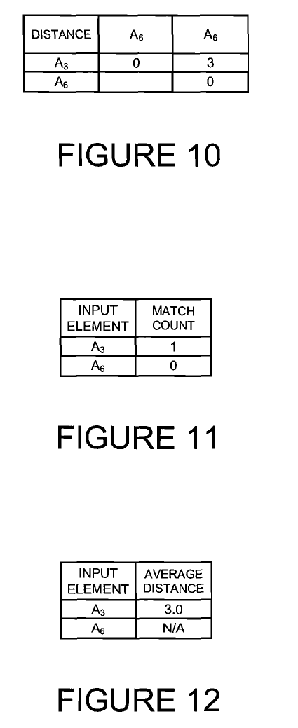

One or more elements may be removed from consideration if they are within a distance threshold at block 914. By way of example, elements A₂, A₄, A₅ may be removed from consideration as their values from the distance table 600 are within the distance threshold 406 of the element selected as being representative (e.g., element A₁), such that elements A₂, A₄, A₅ are considered functionally equivalent to A₁. FIG. 10 illustrates an updated distance table 1000 after the elements have been removed from consideration, such that remaining elements are not considered functionality equivalent to A₁.

At decision block 916, a determination may be made as to whether there are any additional elements to consider. For example, there may be additional elements to consider when elements (e.g., fingerprints) are remaining in the set of elements (e.g., the set of fingerprints).

If there are additional elements to consider, the method 900 may return to block 906. If there are no additional elements to consider at decision block 916, the method 900 may terminate at block 918.

In an example embodiment, if there are additional elements to consider at decision block 916, the method 900 may repeat the operations performed at decision block 908, block 912, and block 914 to select one or more outlying elements (e.g., outlying fingerprints) by clustering.

In an example embodiment, the representative fingerprint and any outlying fingerprints may be a representative fingerprint set of reference data 112 for the digital content 104.

As further shown by way of example, an updated match table 1100 and an updated average distance table 1200 may be computed from the updated distance table 1000 (see FIGS. 10-12). Since element A₃ has the greatest match count, element A₃ may be added to the output set 418.

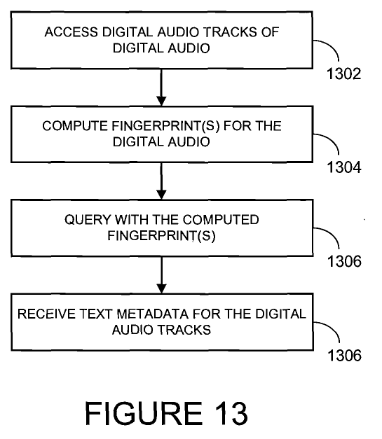

Referring to FIG. 13, a method 1300 for receiving text metadata according to an example embodiment is illustrated. In an example embodiment, the method 1400 may be performed on the computing system 202 (see FIG. 2).

One or more digital audio tracks may be accessed from the digital audio 204 (see FIG. 2) at block 1302. One or more fingerprints from the master fingerprint collection may respectively be computed for the one or more digital audio tracks at block 1304. The recognition server 208 may be queried with the computed fingerprints at block 1306. Text metadata 226 may be received from the recognition server 208 for the digital audio tracks at block 1306. Upon completion of block 1306, the method 1300 may terminate.

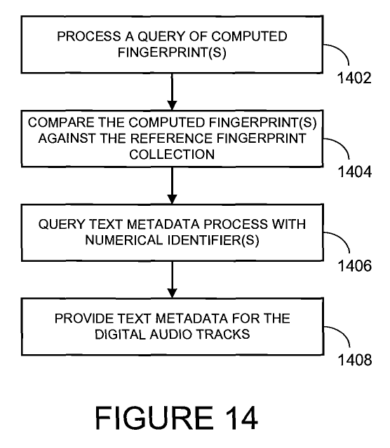

Referring to FIG. 14, a method 1400 for providing text metadata according to an example embodiment is illustrated. In an example embodiment, the method 1400 may be performed on the recognition apparatus 208 (see FIG. 2).

A query of computed fingerprints may be processed at block 1402. The computed fingerprints may be compared against the reference fingerprint collection 222 to obtain one or more numerical identifiers at block 1404. The text metadata 226 may be queried with numerical identifiers at block 1406, and the relevant text metadata 226 may be provided for the digital audio tracks at block 1408. After block 1408, the method 1400 may terminate.

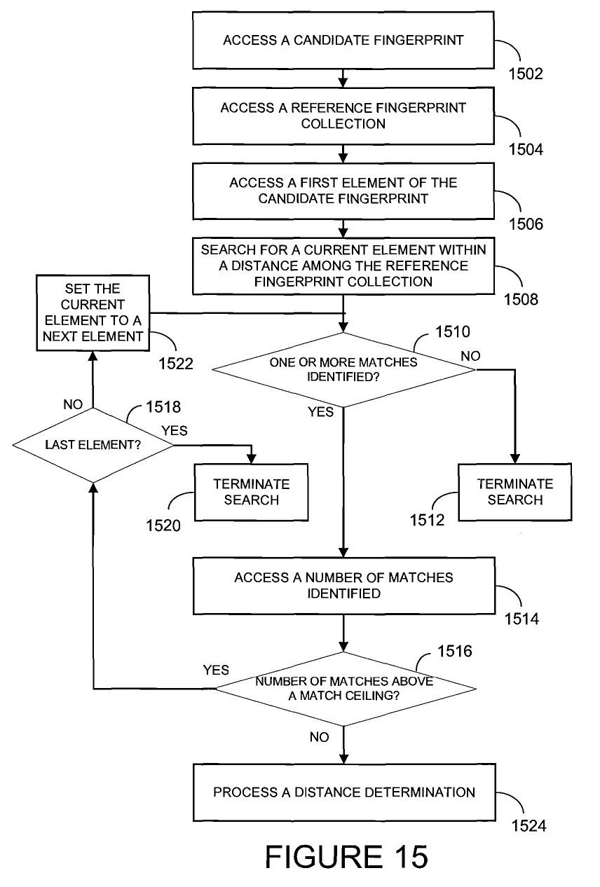

FIG. 15 shows a flowchart of an example method 1500 for searching a database of reference fingerprints. In an example embodiment, the method 1500 may be performed at block 1404 (see FIG. 14).

A candidate fingerprint may be accessed at block 1502. For example, the candidate fingerprint may be a fingerprint of a digital audio track for which text metadata 226 is desired. In an example embodiment, a method described in U.S. application Ser. No. 10,200,034 entitled “AUTOMATIC IDENTIFICATION OF SOUND RECORDINGS” may be used to obtain the candidate fingerprint.

The reference fingerprint collection 222 may be accessed at block 1504. A first element of the candidate fingerprint may be accessed as a current element at 1506.

At block 1508, the current element of the candidate fingerprint may be searched against the first element of each of the reference fingerprints of the reference fingerprint collection 222, such that the search may seek a corresponding reference element within a distance of the current element among the reference fingerprints. For example, the distance may correspond with vector thresholds.

At decision block 1510, a determination may be made as to whether one or more matches were identified. If no matches were found, the search may be terminated at block 1512, thereby indicating that a corresponding fingerprint could not be identified within the reference fingerprint collection 222. If one or more matches were identified at decision block 1510, a number of matches identified by the search may be accessed at block 1514.

The method 1500 may determine whether the number of matches is above a match ceiling (or a maximum match threshold). If the number of matches is above the match ceiling, at decision block 1518 the method 1500 may determine whether the current element of the candidate is a last element. If the current element being considered is not a last element, a next element of the candidate fingerprint may be accessed as the current fingerprint at block 1522 and the method 1500 may return to decision block 1510 to again determine a number of matches identified. If the current element is the last element at decision block 1518, the method 1500 may terminate the search at block 1520, thereby indicating that there were too many matches to identify a manageable number of matching fingerprints.

If the number of matches did not exceed the match ceiling at decision block 1516, the method 1500 may process a distance determination at the block 1522. An example embodiment of processing the distance determination is described in greater detail below.

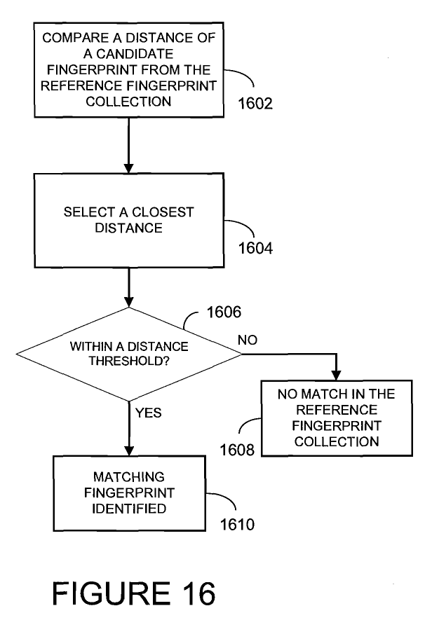

Referring to FIG. 16, an example method 1600 for processing a distance determination is illustrated. The method 1600 may be performed at block 1524 (see FIG. 15).

The method 1600 may compare a distance of a candidate fingerprint from the reference fingerprints in the reference fingerprint collection at block 1602. The method 1600 may then select a closest distance at block 1604.

At decision block 1606, the method 1600 may determine whether the closest distance is within a distance threshold. If the closest distance is not within the distance threshold, the method 1600 may identify that no match was found in the reference fingerprint collection 222 at block 1608. If the closest distance is within the distance threshold at decision block 1606, the matching fingerprint having the closest distance may be identified at block 1610. After block 1608 or block 1610, the method 1600 may terminate.

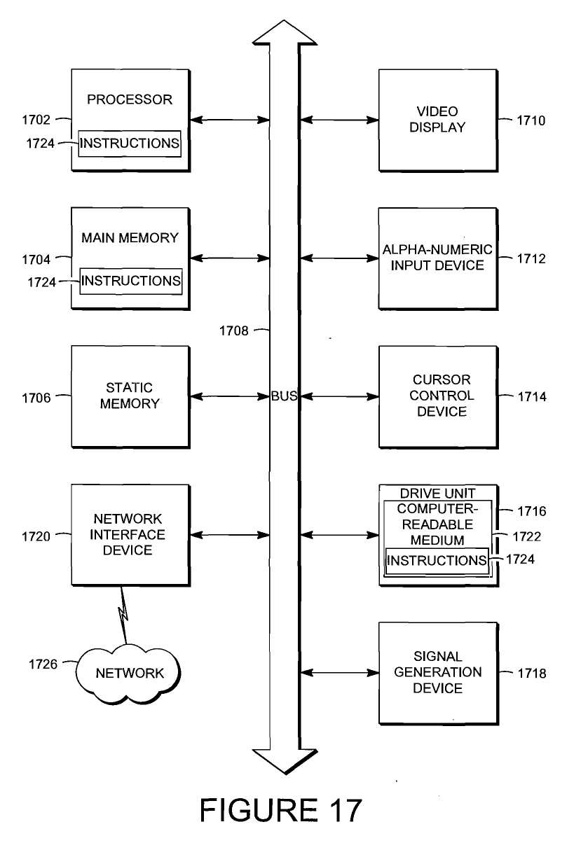

FIG. 17 shows a diagrammatic representation of machine in the exemplary form of a computer system 1700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an MP3 player), a car audio device, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1700 includes a processor 1702 (e.g., a central processing unit (CPU) a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard), a cursor control device 1714 (e.g., a mouse), a disk drive unit 1716, a signal generation device 1718 (e.g., a speaker) and a network interface device 1730.

The disk drive unit 1716 includes a machine-readable medium 1722 on which is stored one or more sets of instructions (e.g., software 1724) embodying any one or more of the methodologies or functions described herein. The software 1724 may also reside, completely or at least partially, within the main memory 1704 and/or within the processor 1702 during execution thereof by the computer system 1700, the main memory 1704 and the processor 1702 also constituting machine-readable media.

The software 1724 may further be transmitted or received over a network 1726 via the network interface device 1730.

While the machine-readable medium 1722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The embodiments described herein may be implemented in an operating environment comprising software installed on a computer, in hardware, or in a combination of software and hardware.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
accessing identifiers of a content portion of digital content, the identifiers usable to identify the content portion and associated with multiple different sources of the content portion; and
defining reference data for the content portion by clustering the accessed identifiers, the reference data usable to identify the content portion.

2. The method of claim 1, further comprising:
publishing the reference data.

3. The method of claim 1, further comprising:
selecting a master fingerprint collection as the source data.

4. The method of claim 3, further comprising:
selecting a digital audio track as the content portion; and
selecting one or more fingerprints of a digital audio track as the reference data.

5. The method of claim 1, further comprising:
processing the content portion of digital content to create and store the source data.

6. The method of claim 1, further comprising:
selecting at least one of still pictures/photographs, video, or audio as the digital content.

7. A method comprising:
selecting a representative fingerprint from a set of fingerprints for a digital audio track by clustering; and
indexing the representative fingerprint for search queries.

8. The method of claim 7, further comprising:
selecting one or more outlying fingerprints for the digital audio track by clustering; and
indexing the one or more outlying fingerprints for the search queries.

9. The method of claim 8, further comprising:
publishing the representative fingerprint and the one or more outlying fingerprints.

10. The method of claim 7, further comprising:
performing a table of contents search within a master fingerprint collection to identify a set of fingerprints associated with a digital audio track.

11. The method of claim 8, wherein the clustering comprises:
computing distance values between each of the fingerprints of the set of fingerprints by use of a distance function;
calculating a number of matches by computing a number of the distance values below a distance threshold for each of the fingerprints; and
selecting the fingerprint with a largest number of matches as the representative fingerprint.

12. The method of claim 11, wherein the clustering further comprises:
repeating the following steps:
removing fingerprints within a distance threshold from the set of fingerprints from consideration,
calculating the number of matches by determining the number of the distance values below the distance threshold for each of the fingerprints remaining in the set of fingerprints, and
selecting the fingerprint with the largest number of matches as an outlying fingerprint of the one or more outlying fingerprints,
until there are no remaining fingerprints among the set of fingerprints for consideration.

13. The method of claim 8, wherein the clustering comprises:
computing distance values between each of the fingerprints of the set of fingerprints by use of a distance function;
calculating a number of matches by determining a number of the distance values below a distance threshold for each of the fingerprints; and
selecting one or more of the fingerprints with a largest number of matches;
calculating an average distance for each of the fingerprints from the fingerprints matched; and
selecting a fingerprint with a lowest average distance from the one or more of the fingerprints with a largest number of matches as the representative fingerprint.

14. The method of claim 13, wherein the clustering further comprises:
repeating the following steps:
removing fingerprints within a distance threshold from the set of fingerprints from consideration,
calculating the number of matches by determining the number of the distance values below the distance threshold for each of the fingerprints remaining in the set of fingerprints,
selecting one or more of the fingerprints with a largest number of matches,
calculating an average distance for each of the fingerprints from the fingerprints matched, and
selecting a fingerprint with a lowest average distance from the one or more of the fingerprints with a largest number of matches as an outlying fingerprint of the one or more outlying fingerprints,
until there are no remaining fingerprints among the set of fingerprints for consideration.

15. The method of claim 11, further comprising selecting at least one of an Itakura distance function, a Levenshtein/edit distance function, a Euclidian distance function, or a cross product distance function as a distance function.

16. A machine-readable medium comprising instructions, which when executed by a machine, cause the machine to:
access source data for a content portion of digital content, the source data usable to identify the content portion; and
define reference data for the content portion by clustering the accessed source data, the reference data usable to identify the content portion.

17. A machine-readable medium comprising instructions, which when executed by a machine, cause the machine to:
select a representative fingerprint from a set of fingerprints for a digital audio track by clustering; and
index the representative fingerprint for search queries.

18. A machine-readable medium comprising instructions, which when executed by a machine, cause the machine to:
compute distance values between each fingerprint of a set of fingerprints by use of a distance function;
calculate a number of matches by computing a number of the distance values below a distance threshold for each of the fingerprints of the set of fingerprints; and
select the fingerprint with a largest number of matches as a representative fingerprint.

19. A machine-readable medium comprising instructions, which when executed by a machine, cause the machine to:
calculate a number of matches by determining a number of the distance values below a distance threshold for each fingerprint of a set of fingerprints; and
select one or more of the fingerprints with a largest number of matches;
calculate an average distance for each of the fingerprints from the fingerprints matched; and
select a fingerprint with a lowest average distance from the one or more of the fingerprints with a largest number of matches as a representative fingerprint.

20. An apparatus comprising:
means for accessing identifiers of a content portion of digital content, the identifiers usable to identify the content portion and associated with multiple different sources of the content portion; and
means for defining reference data for the content portion by clustering the accessed identifiers, the reference data usable to identify the content portion.

21. An apparatus comprising:
a reference fingerprint collection comprising a representative set of fingerprints selected from a master fingerprint collection by clustering;
numerical identifiers to individually identify fingerprints among the representative set of fingerprints; and
text metadata to provide information regarding digital content associated with the representative set of fingerprints.

22. The apparatus of claim 21, wherein the text metadata comprises at least one of an album name, an artist name, a track title, a genre, a year, notes, table of contents (TOC) for CDs, or TOC for DVDs.

23. The apparatus of claim 21, wherein the digital content includes digital audio.

24. A method of providing identifiers associated with known digital content items, the method comprising:
for each known digital content item of a plurality of content items,
generating a plurality of identifiers associated with the known digital content item;
identifying at least two similar identifiers among the plurality of identifiers; and
storing a reference set of identifiers that excludes at least one similar identifier.
